(19) United States
(12) Patent Application Publication
(10) Pub. No.: US 2025/0076378 A1
(43) Pub. Date: Mar. 6, 2025

(54) SOC CHIP DISTRIBUTED SIMULATION AND VERIFICATION PLATFORM AND METHOD

(71) Applicant: Jinan Xinyu Software Technology Co., Ltd., Jinan, Shandong (CN)

(72) Inventors: Min Yi, Jinan, Shandong (CN); Yunzhao Yang, Jinan, Shandong (CN); Min Cheng, Jinan, Shandong (CN); Chuanqiang Shen, Jinan, Shandong (CN); Ming Wei, Jinan, Shandong (CN); Tianhao Yi, Jinan, Shandong (CN)

(21) Appl. No.: 18/726,421

(22) PCT Filed: Apr. 12, 2023
(86) PCT No.: PCT/CN2023/087853

§ 371 Date: Jul. 3, 2024

(30) Foreign Application Priority Data
Sep. 22, 2022 (CN) 202211154475.7

(51) Int. Cl. G01R 31/3183; G01R 31/317

(52) U.S. Cl. CPC G01R 31/318357; G01R 31/31704

(57) ABSTRACT

The present disclosure discloses an SoC chip distributed simulation and verification platform and a method, and the present disclosure relates to the field of chip verification technologies. The distributed simulation and verification platform includes component modules of an SoC chip; each module has its own verification platform, and each verification platform separately runs in a different simulation process; and virtual connections between the modules are implemented through respective verification platforms, to implement system function simulation and verification. In the present disclosure, a virtual connection technology is used to connect Testbench test platforms of the modules or IPs, to implement virtual integration of the modules or IPs, thereby completing distributed simulation and verification of a system function of the SoC chip.

### CROSS-REFERENCE TO RELATED APPLICATION

This application claims the benefit of Chinese Patent Application No. 202211154475.7, filed on Sep. 22, 2022, which is hereby incorporated by reference in its entirety including any tables, figures, or drawings.

### TECHNICAL FIELD

The present disclosure relates to the field of chip verification technologies, and in particular, to an SoC chip distributed simulation and verification platform and a method.

### BACKGROUND

In a chip simulation and verification process of a system on chip (SoC), due to an increasing scale of chips, a computation amount of a simulation task is increasingly large, simulation time is increasingly long, a chip development cycle becomes longer, and development costs are increased. How to improve execution efficiency of simulation and verification has always been a key research focus in the industry.

An SoC chip includes a large quantity of modules (Module) or intellectual properties (IPs). Development and verification processes of the SoC chip are as follows:
(1) development of the modules;
(2) establishment of a module verification platform (Testbench), and module verification;
(3) IP evaluation and purchase;
(4) establishment of an IP verification platform (Testbench), and IP verification;
(5) SoC chip integration: The modules and the IPs are integrated together to form the SoC chip; and
(6) establishment of an SoC chip verification platform (Testbench), and SoC verification.

It should be noted that the modules and the IPs in the SoC chip both refer to functional design modules of the SoC chip, differing only in whether the modules and the IPs are independently developed or purchased function modules.

An example of the foregoing steps is shown in FIG. 1. In the example, anSoC chip includes three modules and three IPs. Each module and each IP have their own verification platforms Testbench 1, 2, . . . , and 6, and a verification platform of the SoC chip is Testbench 7.

As shown in FIG. 1, the three modules and the three IPs may respectively run on six CPU cores in simulation and verification before integration. After being integrated together, the three modules and the three IPs can only run on one CPU core during simulation.

There are generally several, more than ten, or dozens of modules and IPs in the SoC chip. When simulation and verification are performed on the modules and the IPs, simulation duration of a single test case is between a few minutes and a few hours due to a relatively small scale of the modules and the IPs. Because the SoC chip includes a large quantity of modules and IPs, a scale of the SoC chip is large, simulation and verification duration naturally increases a lot, and a single test case takes several hours to more than ten days.

Currently, a hardware simulation acceleration or software simulation acceleration technology is generally used to accelerate the simulation and verification. However, hardware simulation acceleration requires a hardware accelerator, and costs are high, which is difficult to be implemented by engineering; and software simulation acceleration only improves simulation efficiency to a certain extent. However, because design code cannot be separated, design code still needs to be simulated and verified on a same CPU core, and time consumption is still high.

### SUMMARY

Therefore, to resolve a problem that an existing software simulation acceleration technology has high time consumption and low simulation efficiency, the present disclosure provides an SoC chip distributed simulation and verification platform. In the present disclosure, a virtual connection technology is used to connect test platforms (Testbenches) of modules or IPs, to implement virtual integration of the modules or IPs, thereby completing distributed simulation and verification of a system function of an SoC chip.

The present disclosure is implemented by the following technical solutions:

An SoC chip distributed simulation and verification platform includes component modules of an SoC chip, where
each module has its own verification platform, and each verification platform separately runs in a different simulation process; and
virtual connections between the modules are implemented through respective verification platforms, to implement system function simulation and verification.

In some embodiments, the virtual connections in the present disclosure include connections between data layers and between signal layers;
the connection between the data layers is specifically that data is transmitted between the verification platforms of different modules by using a virtual connection communication protocol; and
the connection between the signal layers is specifically that a signal connection is established between a module and the verification platform of the same module.

In some embodiments, the virtual connection communication protocol in the present disclosure uses a VLink protocol, to implement point-to-point, bidirectional, and duplex data communication.

In some embodiments, a data structure of data transmitted between verification platforms of different modules in the present disclosure is determined by a functional design of the SoC chip.

In some embodiments, the verification platform in the present disclosure includes component modules of at least one SoC chip.

In some embodiments, the verification platform in the present disclosure is capable of implementing multi-chip joint simulation.

In some embodiments, the verification platform in the present disclosure is capable of implementing cross-area or cross-server simulation of the SoC chip.

In some embodiments, the verification platform in the present disclosure is capable of implementing distributed post-simulation of the SoC chip.

According to another aspect, the present disclosure provides a data transmission method implemented based on the foregoing SoC chip distributed simulation and verification platform. The method includes:
sending, by a module A, data to a verification platform of the module A through a signal line;
sending, by the verification platform of the module A, the received data to a verification platform of a module B in another process through inter-process communication; and
sending, by the verification platform of the module B, the received data to the module B through a signal line, to complete data transmission between the two modules in different processes.

In some embodiments, the method in the present disclosure further includes:
sending, by the module B, data to the verification platform of the module B through the signal line while the module A transmits data to the module B;
sending, by the verification platform of the module B, the received data to the verification platform of the module A in another process through inter-process communication; and
sending, by the verification platform of the module A, the received data to the module A through the signal line, to complete bidirectional data transmission between the two modules in different processes.

The present disclosure has the following advantages and beneficial effects:

1. In the present disclosure, the virtual connection technology is used to connect the test platforms (Testbenches) of the modules and the IPs of the SoC chip, to implement virtual integration of the modules and the IPs in the SoC chip, thereby completing a system function simulation test of the SoC chip. In the present disclosure, simulation and verification of the SoC chip may be allocated to several, more than ten, or even dozens of CPUs, or a plurality of servers to perform simulation, thereby implementing cross-area and multi-process distributed simulation and verification, and improving simulation and verification efficiency.

2. In the conventional technology, simulation of only one chip can be implemented. When a plurality of chips are required on a hardware board, a multi-chip test can be performed only after tape-out of the chips is completed and the hardware board has been debugged. However, in the present disclosure, multi-chip joint simulation can be implemented in a chip simulation phase.

3. During chip simulation and verification, chip post-simulation is a scenario in which simulation time is longer. Chip pre-simulation can be accelerated by using a hardware accelerator, but the chip post-simulation cannot be accelerated by using a hardware accelerator. Therefore, a timing parameter added to a chip post-simulation network table can only be simulated through calculation, and the hardware accelerator does not have these calculation functions. A distributed simulation architecture is used in the present disclosure, and can support post-simulation of the SoC chip.

### BRIEF DESCRIPTION OF DRAWINGS

The accompanying drawings described herein are used to provide further understanding of embodiments of the present disclosure, and constitute a part of the present application, but does not constitute limitations to the embodiments of the present disclosure. In the accompanying drawings:

FIG. 1 is a conventional SoC chip simulation and verification architecture;

FIG. 2 is a schematic diagram of an architecture of an SoC chip distributed simulation and verification platform according to an embodiment of the present disclosure;

FIG. 3 is a schematic diagram of a conventional physical connection; and

FIG. 4 is a schematic diagram of a virtual connection according to an embodiment of the present disclosure.

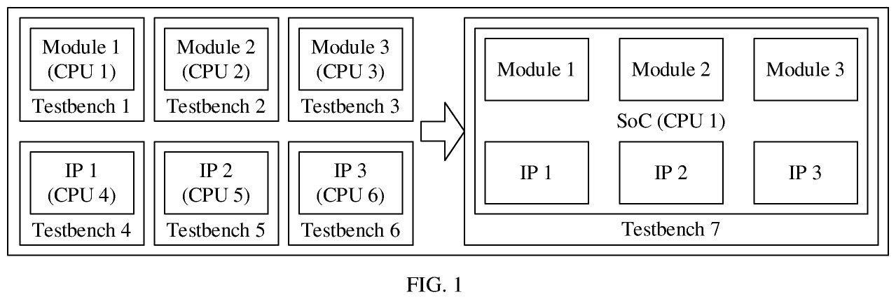

### DESCRIPTION OF EMBODIMENTS

To make the objectives, technical solutions and advantages of the present disclosure clearer, the present disclosure is further described in detail below with reference to embodiments and the accompanying drawing. The schematic implementations of the present disclosure and descriptions thereof are only used to explain the present disclosure, but are not intended to limit the present disclosure.

### Embodiments

In a conventional SoC simulation and verification process, after simulation and verification of modules and IPs are completed, the modules and the IPs need to be integrated into one SoC chip first, and then simulation is performed on a same CPU. In this way, the SoC chip formed through integration of a plurality of modules and IPs can be executed on only one CPU, resulting in relatively low simulation and verification efficiency. In particular, for some SoC chips that include more than ten or even dozens of modules, execution efficiency is lower. In view of this, an embodiment of the present disclosure provides an SoC chip distributed simulation and verification platform, which connects test platforms (Testbenches) of modules through a virtual connection technology, and performs virtual integration on the modules of an SoC chip, to complete a system function test of the SoC chip, thereby implementing multi-machine, multi-process, and distributed simulation and verification, and improving simulation and verification efficiency. It should be noted that the virtual integration described in this embodiment of the present disclosure is only used for simulation and verification of the SoC chip, to improve simulation and verification efficiency, but cannot replace a physical integration process of the SoCchip.

The distributed simulation and verification platform provided in this embodiment of the present disclosure mainly includes component modules of the SoC chip and test platforms (Testbenches) established for the component modules, and each test platform (Testbench) runs in a different process. The distributed simulation and verification platform in this embodiment of the present disclosure connects the test platforms (Testbenches)_of the modules through virtual connections, to perform data transmission, thereby implementing simulation and verification of the SoC chip.

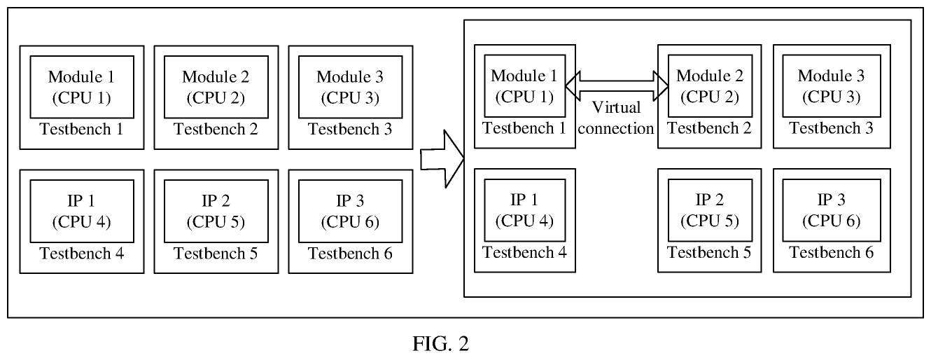

In this embodiment of the present disclosure, an architecture of the SoC chip distributed simulation and verification platform, as shown in FIG. 2, is used as an example for description. As shown in FIG. 2, the SoC chip distributed simulation and verification platform provided in this embodiment of the present disclosure includes three modules (respectively Module 1, Module 2, and Module 3) and three IPs (respectively IP 1, IP 2, and IP 3), and each module and each IP have their own verification platforms: Testbench 1, Testbench 2, Testbench 3, Testbench 4, Testbench 5, and Testbench 6. According to system functions, virtual connections are established on the Testbench of each module and the Testbench of each IP, to implement data transmission, thereby completing a system function test.

It should be noted that FIG. 2 shows an architecture of a distributed simulation and verification platform of only one SoC chip, but is not limited thereto. For example, in another implementation, a quantity of modules may be determined by system functions of the SoC chip, and may be determined when the SoC chip is designed. Alternatively, in another implementation, simulation and verification of two or more SoC chips may be implemented. That is, the distributed simulation and verification platform provided in this embodiment of the present disclosure may not only allocate a plurality of modules of the SoC chip to a plurality of CPUs of a plurality of servers for execution, but also allocate a plurality of modules of a plurality of chips on a hardware board to a plurality of CPUs of a plurality of servers for execution.

According to a distributed simulation and verification technology provided in this embodiment of the present disclosure, the modules of the SoC chip do not need to be integrated together, but the test platforms (Testbenches) corresponding to the modules are integrated together, to implement virtual connections of the modules. Each Testbench runs in a different simulation process. That is, the distributed simulation and verification platform provided in this embodiment of the present disclosure allocates a simulation and verification task that can be previously integrated into only one CPU to a plurality of CPUs of a plurality of servers for execution, thereby improving simulation efficiency by at least 2 to 10 times.

The distributed simulation and verification technology provided in this embodiment of the present disclosure uses a software simulation acceleration technology, so that software simulation efficiency is greatly improved, and dependence on a hardware accelerator is reduced. In addition, relative to the hardware accelerator, software simulation acceleration has lower costs and higher flexibility.

For ease of description, relative to a virtual connection, an existing integrated connection in this embodiment of the present disclosure is referred to as a physical connection.

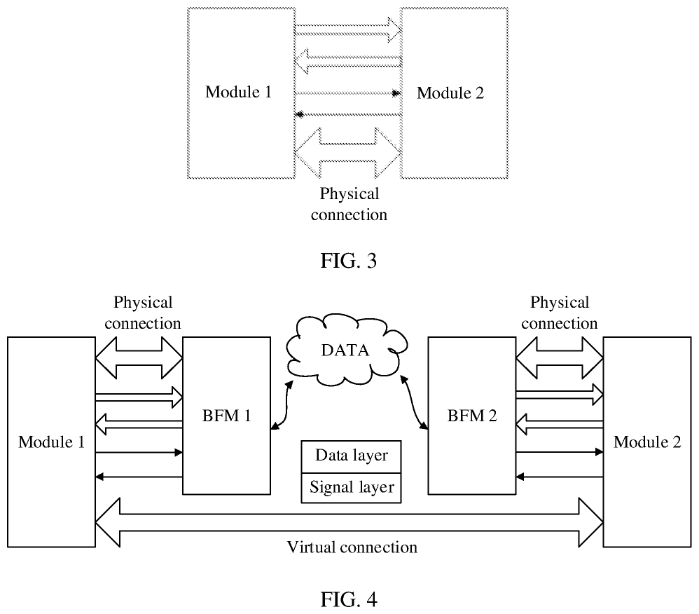

A physical connection between modules is to connect the modules through various signal lines, and data is transmitted on the signal lines, as shown in FIG. 3. A virtual connection manner between modules is shown in FIG. 4.

Virtual connections include a virtual connection between data layers and a virtual connection between signal layers.

A data layer includes a data structure, and a signal layer is of a physical connection. As shown in FIG. 4, Module 1 and BFM 1 are physically connected to each other, Module 2 and BFM 2 are physically connected to each other, and BFM 1 and BFM 2 perform data transmission. In this way, Module 1 and Module 2 implement a virtual connection. A bus function model (BFM) is a part of a test platform Testbench.

The virtual connection uses a virtual link (VLink) protocol, and has the following features:
(1) The VLink protocol is a point-to-point protocol;
(2) data transmission is bidirectional transmission; and
(3) bidirectional data transmission can be simultaneous transmission in two directions (that is, duplex), without affecting each other.

In this embodiment of the present disclosure, a virtual connection instance shown in FIG. 4 is used for description.

Module 1 sends data to BFM 1 through a physical connection, BFM 1 sends the received data to BFM 2 in another process through inter-process communication, and BFM 2 sends the received data to Module 2 through a physical connection. Reverse direction data sending (that is, Module 2 sends data to Module 1) is implemented by using a similar process.

The objectives, technical solutions, and beneficial effects of the present disclosure are further described in detail in the above specific implementations. It should be understood that the foregoing descriptions are only specific implementations of the present disclosure and are not intended to limit the protection scope of the present disclosure. Any modification, equivalent replacement, improvement, and the like made within the spirit and principle of the present disclosure should fall within the protection scope of the present disclosure.

1. An SoC chip distributed simulation and verification platform, comprising component modules of an SoC chip, wherein
each module has its own verification platform, and each verification platform separately runs in a different simulation process; and
virtual connections between the modules are implemented through respective verification platforms, to implement system function simulation and verification.

2. The SoC chip distributed simulation and verification platform according to claim 1, wherein the virtual connections comprise connections between data layers and between signal layers;
the connection between the data layers is specifically that data is transmitted between the verification platforms of different modules by using a virtual connection communication protocol; and
the connection between the signal layers is specifically that a signal connection is established between a module and the verification platform of the same module.

3. The SoC chip distributed simulation and verification platform according to claim 2, wherein the virtual connection communication protocol uses a VLink protocol, to implement point-to-point, bidirectional, and duplex data communication.

4. The SoC chip distributed simulation and verification platform according to claim 2, wherein a data structure of data transmitted between verification platforms of different modules is determined by a functional design of the SoC chip.

5. The SoC chip distributed simulation and verification platform according to claim 1, comprising component modules of at least one SoC chip.

6. The SoC chip distributed simulation and verification platform according to claim 1, wherein the verification platform is capable of implementing multi-chip joint simulation.

7. The SoC chip distributed simulation and verification platform according to claim 1, wherein the verification platform is capable of implementing cross-area or cross-server simulation of the SoC chip.

8. The SoC chip distributed simulation and verification platform according to claim 1, wherein the verification platform is capable of implementing distributed post-simulation of the SoC chip.

9. A data transmission method, wherein the method is implemented based on the SoC chip distributed simulation and verification platform according to claim 1, and the method comprises:
sending, by a module A, data to a verification platform of the module A through a signal line;
sending, by the verification platform of the module A, the received data to a verification platform of a module B in another process through inter-process communication; and
sending, by the verification platform of the module B, the received data to the module B through a signal line, to complete data transmission between the two modules in different processes.

10. The data transmission method according to claim 9, wherein the method further comprises:
sending, by the module B, data to the verification platform of the module B through the signal line while the module A transmits data to the module B;
sending, by the verification platform of the module B, the received data to the verification platform of the module A in another process through inter-process communication; and
sending, by the verification platform of the module A, the received data to the module A through the signal line, to complete bidirectional data transmission between the two modules in different processes.

11. The SoC chip distributed simulation and verification platform according to claim 2, comprising component modules of at least one SoC chip.

12. The SoC chip distributed simulation and verification platform according to claim 3, comprising component modules of at least one SoC chip.

13. The SoC chip distributed simulation and verification platform according to claim 4, comprising component modules of at least one SoC chip.

14. The SoC chip distributed simulation and verification platform according to claim 2, wherein the simulation and verification platform is capable of implementing multi-chip joint simulation.

15. The SoC chip distributed simulation and verification platform according to claim 2, wherein the simulation and verification platform is capable of implementing cross-area or cross-server simulation of the SoC chip.

16. The SoC chip distributed simulation and verification platform according to claim 2, wherein the simulation and verification platform is capable of implementing distributed post-simulation of the SoC chip.

17. A data transmission method, wherein the method is implemented based on the SoC chip distributed simulation and verification platform according to claim 2, and the method comprises:
sending, by a module A, data to a verification platform of the module A through a signal line;
sending, by the verification platform of the module A, the received data to a verification platform of a module B in another process through inter-process communication; and
sending, by the verification platform of the module B, the received data to the module B through a signal line, to complete data transmission between the two modules in different processes.

18. The data transmission method according to claim 17, wherein the method further comprises:
sending, by the module B, data to the verification platform of the module B through the signal line while the module A transmits data to the module B;
sending, by the verification platform of the module B, the received data to the verification platform of the module A in another process through inter-process communication; and
sending, by the verification platform of the module A, the received data to the module A through the signal line, to complete bidirectional data transmission between the two modules in different processes.
